(19) United States
(12) Patent Application Publication
(10) Pub. No.: US 2011/0184129 A1
(43) Pub. Date: Jul. 28, 2011

(54) METHOD FOR PRODUCING ETHYLENE COPOLYMERS

(75) Inventors: Frank-Olaf Mähling, Mannheim (DE); Thomas Pfeiffer, Bohl-Iggelheim (DE); Wolfgang Kasel, Nussloch (DE); Heike Pfistner, Ludwigshafen (DE)

(73) Assignee: BASF SE, Ludwigshafen (DE)

(21) Appl. No.: 12/301,776

(22) PCT Filed: May 15, 2007
(86) PCT No.: PCT/EP2007/054720

§ 371 Date: Nov. 21, 2008

(30) Foreign Application Priority Data
May 23, 2006 (EP) 06114405.1

(51) Int. Cl. C08F 220/06; C08F 2/06; C08F 2/00

(52) U.S. Cl. 526/64; 526/329; 526/89; 526/204

(57) ABSTRACT

Process for the continuous preparation of ethylene copolymers by free-radical copolymerization of ethylene and at least one comonomer (b) selected from among ethylenically unsaturated carboxylic acids, esters of ethylenically unsaturated carboxylic acids, ethylenically unsaturated phosphonic acids and esters of ethylenically unsaturated phosphonic acids, wherein one or more inhibitors are metered separately from ethylene and the comonomer or comonomers (b) into the reaction mixture.

The present invention relates to a process for the continuous preparation of ethylene copolymers by free-radical copolymerization of ethylene and at least one comonomer (b) selected from among ethylenically unsaturated carboxylic acids, esters of ethylenically unsaturated carboxylic acids, ethylenically unsaturated phosphonic acids and esters of ethylenically unsaturated phosphonic acids, wherein one or more inhibitors are metered separately from ethylene and the comonomer or comonomers (b) into the reaction mixture.

Copolymers of ethylene with one or more comonomers such as ethylenically unsaturated carboxylic acids and esters of ethylenically unsaturated carboxylic acids are preferably prepared continuously in the high-pressure process. For this purpose, copolymerization is carried out at pressures in the range from 500 to 5000 bar using one or more free-radical initiators. Ethylene, which is generally present in the supercritical state in the high-pressure process, serves as reaction medium. The copolymerization can also be carried out in the presence of one more molar mass regulators (regulators). Products obtained are, depending on the mode of operation, ethylene copolymers having relatively high (Mₙ above 20 000 g/mol) or relatively low (Mₙ not more than 20 000 g/mol) molecular weights, which in many cases can be processed to form emulsions. Such emulsions can, for example, be used as or for producing floor care products.

However, it is found in many cases that the preparation of emulsifiable ethylene copolymers results in formation of ethylene copolymers which comprise a proportion of polar components (copolymerized ethylenically unsaturated acids, in particular carboxylic acids, or esters thereof) which is too low. If an attempt is made to produce emulsions from such ethylene copolymers, turbid mixtures which can sometimes be stored with formation of residues and in other cases cannot be stored at all without severely troublesome demixing are formed.

It is known that inhibitors such as TEMPO (2,2,6,6-tetramethylpiperidin-N-oxyl) can be added during compression of the comonomer or comonomers to prevent formation of deposits in the compressor, cf., for example, DE 196 22 441. The cited document discloses that it is advantageous to introduce an inhibitor between the precompressor and the after-compressor. The (co)monomer(s) are subsequently metered in together with the inhibitor or inhibitors.

It is known from WO 01/60875 that the (co)monomer(s) can be compressed together with oxygen or NO as gas and subsequently be fed to the polymerization. In this way, too, the tendency for deposits to be formed in the compressor can be reduced.

It is known from U.S. Pat. No. 5,449,724 that ethylene can be heated together with a free-radical initiator and an inhibitor and be polymerized in this way. The examples describe the preparation of a thermoplastic resin which is not emulsifiable.

It was therefore an object of the invention to provide a process by means of which ethylene copolymers which can be emulsified very readily can be prepared.

We have accordingly found the process defined at the outset.

The continuous copolymerization of ethylene (a) and at least one comonomer (b) selected from among ethylenically unsaturated carboxylic acids, esters of ethylenically unsaturated carboxylic acids, ethylenically unsaturated phosphonic acids and esters of ethylenically unsaturated phosphonic acids can, according to the invention, be carried out in the form of a free-radically initiated copolymerization, preferably under high-pressure conditions, for example in continuously operated stirred high-pressure autoclaves, hereinafter also referred to as high-pressure autoclaves, or in high-pressure tube reactors, hereinafter also referred to as tube reactors. The preparation in cascades comprising at least two high-pressure autoclaves, comprising at least two tube reactors or comprising a high-pressure autoclave and a tube reactor is preferred; particular preference is given to cascades comprising a high-pressure autoclave and a tube reactor.

Stirred high-pressure autoclaves are known per se; a description may be found in Ullmann's Encyclopedia of Industrial Chemistry, 5th edition, keyword: waxes, vol. A 28, p. 146 ff., Verlag Chemie Weinheim, Basel, Cambridge, New York, Tokyo, 1996. Their length/diameter ratio is preferably in the range from 5:1 to 30:1, more preferably from 10:1 to 20:1. The high-pressure tube reactors which can likewise be employed are also described in Ullmann's Encyclopedia of Industrial Chemistry, 5th edition, keyword: waxes, vol. A 28, p. 146 ff., Verlag Chemie Weinheim, Basel, Cambridge, New York, Tokyo, 1996.

In an embodiment of the present invention, the copolymerization is carried out at pressures in the range from 500 to 4000 bar, preferably from 1500 to 2500 bar. Conditions of this type will hereinafter also be referred to as high pressure.

In an embodiment of the present invention, the copolymerization is carried out at reaction temperatures in the range from 120 to 300° C., preferably in the range from 170 to 280° C. The reaction temperature does not have to be the same at all points of the apparatus used. Particularly when a tube reactor or a cascade is used, the reaction temperature can assume different values over the apparatus.

In an embodiment of the present invention, the process of the invention is carried out by copolymerizing
(a) from 60 to 98% by weight, preferably from 75 to 82% by weight, particularly preferably up to 80% by weight, of ethylene,
(b) from 2 to 40% by weight, preferably from 18 to 25% by weight, particularly preferably up to 20% by weight, of at least one comonomer selected from among ethylenically unsaturated carboxylic acids, esters of ethylenically unsaturated carboxylic acids, ethylenically unsaturated phosphonic acids and esters of ethylenically unsaturated phosphonic acids,
(c) if appropriate, one or more further comonomers, for example in an amount of up to 20% by weight, preferably up to 5% by weight.

Here, the figures in percent by weight are in each case based on the total ethylene copolymer prepared according to the invention.

As ethylenically unsaturated carboxylic acid, preference is given to selecting at least one carboxylic acid of the general formula I,

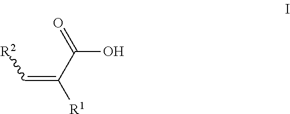

where the variables are defined as follows:
R¹ and R² are identical or different,
R¹ is selected from among hydrogen and branched and unbranched C₁-C₁₀-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, isooctyl, 2-ethylhexyl, n-nonyl, n-decyl, 2-n-propylheptyl; particularly preferably C₁-C₄-alkyl such as methyl, ethyl, n-propyl, isopropyl, n-butyl, isobutyl, sec-butyl and tert-butyl, in particular methyl;
R² is selected from among unbranched and branched C₁-C₁₀-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, isooctyl, 2-ethylhexyl, n-nonyl, n-decyl, 2-n-propylheptyl; particularly preferably C₁-C₄-alkyl such as methyl, ethyl, n-propyl, isopropyl, n-butyl, isobutyl, sec-butyl and tert-butyl, in particular methyl;
and very particularly preferably hydrogen.

As an example of ethylenically unsaturated phosphonic acids, mention may be made of vinylphosphonic acid. Examples of esters of ethylenically unsaturated phosphonic acids are, in particular, dimethyl vinylphosphonate and diethyl vinyiphosphonate.

In an embodiment of the present invention, R¹ is hydrogen or methyl. R¹ is very particularly preferably methyl.

In an embodiment of the present invention, R¹ is hydrogen or methyl and R² is hydrogen.

Very particular preference is given to using acrylic acid or methacrylic acid as ethylenically unsaturated carboxylic acid (b) of the general formula I.

If a plurality of ethylenically unsaturated carboxylic acids (b) are to be used, it is possible to use two different ethylenically unsaturated carboxylic acids of the general formula I, for example acrylic acid and methacrylic acid.

In an embodiment of the present invention, (meth)acrylic acid and maleic acid or maleic anhydride are used as ethylenically unsaturated carboxylic acids.

In an embodiment of the present invention, only one ethylenically unsaturated carboxylic acid (b), preferably acrylic acid and particularly preferably methacrylic acid, is used for preparing ethylene copolymers.

Suitable esters of ethylenically unsaturated carboxylic acids are phenyl esters and alkyl esters of the abovementioned ethylenically unsaturated carboxylic acids of the general formula I, in particular C₁-C₁₀-alkyl esters of the abovementioned ethylenically unsaturated carboxylic acids. Preference is given to at least one C₁-C₁₀-alkyl ester of an ethylenically unsaturated carboxylic acid corresponding to a carboxylic ester of the general formula II,

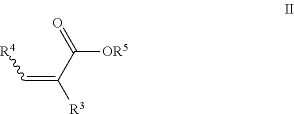

where the variables are defined as follows:
R³ and R⁴ are identical or different,
R³ is selected from among hydrogen and unbranched and branched C₁-C₁₀-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, isooctyl, 2-ethylhexyl, n-nonyl, n-decyl, 2-n-propylheptyl; particularly preferably C₁-C₄-alkyl such as methyl, ethyl, n-propyl, isopropyl, n-butyl, isobutyl, sec-butyl and tert-butyl, in particular methyl;
R⁴ is selected from among unbranched and branched C₁-C₁₀-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, isooctyl, 2-ethylhexyl, n-nonyl, n-decyl, 2-n-propylheptyl; particularly preferably C₁-C₄-alkyl such as methyl, ethyl, n-propyl, isopropyl, n-butyl, isobutyl, sec-butyl and tert-butyl, in particular methyl;
and very particularly preferably hydrogen.

R⁵ is selected from among unbranched and branched C₁-C₁₀-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, isooctyl, 2-ethylhexyl, n-nonyl, n-decyl, 2-n-propylheptyl; particularly preferably 2-ethylhexyl or C₁-C₄-alkyl such as methyl, ethyl, n-propyl, isopropyl, n-butyl, isobutyl, sec-butyl and tert-butyl, in particular methyl, n-butyl or 2-ethylhexyl; C₃-C₁₂-cycloalkyl such as cyclopropyl, cyclobutyl, cyclopentyl, cyclohexyl, cycloheptyl, cyclooctyl, cyclononyl, cyclodecyl, cycloundecyl and cyclododecyl; preference is given to cyclopentyl, cyclohexyl and cycloheptyl.

In an embodiment of the present invention, R³ is hydrogen or methyl. R³ is very particularly preferably hydrogen.

In an embodiment of the present invention, R³ and R⁴ are each hydrogen.

R⁵ is very particularly preferably methyl, n-butyl or 2-ethylhexyl.

Very particular preference is given to using methyl acrylate as C₁-C₁₀-alkyl ester of an ethylenically unsaturated carboxylic acid of the general formula II.

If a plurality of C₁-C₁₀-alkyl esters of one or more ethylenically unsaturated carboxylic acid(s) are to be used, it is possible to use, for example, two different ethylenically unsaturated carboxylic esters of the general formula II, for example methyl acrylate and methyl methacrylate.

In an embodiment of the present invention, methyl(meth)acrylate is used as C₁-C₁₀-alkyl ester of an ethylenically unsaturated carboxylic acid.

In an embodiment of the present invention, only one C₁-C₁₀-alkyl ester of an ethylenically unsaturated carboxylic acid and only one ethylenically unsaturated carboxylic acid are used, in particular acrylic acid or methacrylic acid and methyl(meth)acrylate.

In an embodiment of the present invention for preparing ethylene copolymers, up to 5 parts by weight, based on the sum of ethylene (a) and the above-described comonomer(s) (b), of further comonomers (c), for example vinyl acetate, α-olefins and/or isobutene, can be copolymerized.

In an embodiment of the present invention, no further comonomers (c) are copolymerized.

To trigger the free-radical copolymerization, it is possible to use one or more initiators (free-radical initiators). Suitable initiators are, for example, organic peroxides, oxygen or azo compounds. Mixtures of a plurality of free-radical initiators are also suitable.

Suitable peroxides, selected from among commercially available substances, are didecanoyl peroxide, 2,5-dimethyl-2,5-di(2-ethylhexanoylperoxy)hexane, tert-amyl peroxypivalate, tert-amyl peroxy-2-ethyl hexanoate, dibenzoyl peroxide, tert-butyl peroxy-2-ethylhexanoate, tert-butyl peroxydiethylacetate, tert-butyl peroxydiethylisobutyrate, 1,4-di(tert-butylperoxycarbonyl)cyclohexane as isomer mixture, tert-butyl perisononanoate, 1,1-di(tert-butylperoxy)-3,3,5-trimethylcyclohexane, 1,1-di(tert-butylperoxy)cyclohexane, methyl isobutyl ketone peroxide, tert-butyl peroxyisopropylcarbonate, 2,2-di(tert-butylperoxy)butane and tert-butyl peroxacetate; tert-butyl peroxybenzoate, di-tert-amyl peroxide, dicumyl peroxide, the isomeric di-(tert-butylperoxyisopropyl)benzenes, 2,5-dimethyl-2,5-di-tert-butylperoxyhexane, tert-butyl-cumyl peroxide, 2,5-dimethyl-2,5-di(tert-butylperoxy)hex-3-yne, di-tert-butyl peroxide, 1,3-diisopropylbenzene monohydroperoxide, cumene hydroperoxide and tert-butyl hydroperoxide;

also dimeric or trimeric ketone peroxides as are known from EP-A 0 813 550.

Particularly suitable peroxides are di-tert-butyl peroxide, tert-Amyl peroxypivalate, tert-butyl peroxypivalate, tert-butyl peroxyisononanoate, tert-butyl peroxy-2-ethylhexanoate and 2,2-di-(tert-butylperoxy)butane and mixtures thereof. An azo compound which may be mentioned by way of example is azobisisobutyronitrile (AIBN). Free-radical initiators are introduced in amounts customary for polymerizations.

Numerous commercially available organic peroxides are admixed with stabilizers before they are sold in order to make them easier to handle. Suitable stabilizers are, for example, white oil or hydrocarbons such as, in particular, isododecane. Such stabilizers can act as molecular weight regulators under the conditions of the high-pressure polymerization. For the purposes of the present invention, the use of molecular weight regulators means the additional use of further molecular weight regulators in addition to the use of stabilizers.

In an embodiment of the present invention, ethylene copolymer prepared according to the invention has a melt mass flow rate (MFR) in the range from 0.1 to 100 g/10 min, preferably from 2 to 50 g/10 min, particularly preferably from 5 to 20 g/10 min, measured at 160° C. under a load of 325 g in accordance with DIN 53735.

In an embodiment of the present invention, ethylene copolymer prepared according to the invention has a molecular weight Mₙ in the range up to 20 000 g/mol preferably from 500 to 10 000 g/mol and particularly preferably from 1000 to 9000 g/mol.

In an embodiment of the present invention, ethylene copolymer prepared according to the invention has a molecular weight distribution M_{w}/Mₙ in the range from 1.7 to 20, preferably from 2 to 8.

According to the invention, one or more inhibitors are metered separately from ethylene and the comonomer or comonomers (b) into the reaction mixture.

In the context of the present invention, “separately from the comonomer or comonomers (b)” means that inhibitor is metered into the reaction mixture at a point which is different from the point at which the comonomer or comonomers (b) is/are metered in. If the copolymerization is to be carried out in a cascade comprising a high-pressure autoclave and a tube reactor, the comonomer or comonomers (b) is/are preferably metered into the inlet of the high-pressure autoclave or into the compressor region and the inhibitor or inhibitors is/are metered in at the outlet of the high-pressure autoclave or at the inlet of the tube reactor downstream of the high-pressure autoclave. In another variant, the copolymerization is carried out in a tube reactor, i.e. not in a cascade, and the comonomer(s) (b) is/are metered in at the inlet of the tube reactor and the inhibitor(s) is/are metered in at a point along the tube reactor at which significant reaction of the comonomers has occurred.

In the context of the present invention, “separately from ethylene” means that inhibitor is not metered in together with the main part of the ethylene used, but instead either completely separately or else together with comparatively small proportions of ethylene.

Compounds suitable as inhibitors are compounds which can scavenge reactive free radicals under the reaction conditions of the high-pressure polymerization without initiating a new chain reaction and thereby stop the free-radical chain reaction. These compounds are preferably organic compounds. Examples of suitable compounds are phenolic compounds, in particular hydroquinone and hydroquinone monomethyl ether, and also substituted phenols such as 2,6-di-tert-butyl cresol.

Particular preference is given to sterically hindered amine compounds. For the purposes of the present invention, sterically hindered amine compounds are secondary amines and derivatives of secondary amines which are substituted on the carbon atoms adjacent to the amine nitrogen so that they do not bear a hydrogen atom there.

Preferred derivatives of secondary amines are hydroxylamines.

Preference is given to at least one inhibitor being an N-oxyl compound or a compound which forms an N-oxyl compound under the conditions of the free-radical copolymerization.

Very particularly suitable inhibitors are organic compounds which have an unpaired electron and are nevertheless sufficiently stable, in particular substituted N-oxyl compounds of the general formulae III

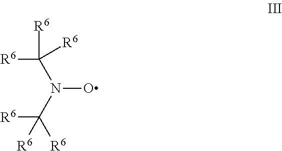

Here, the radicals R⁶ can be identical or different and are selected from among alkyl, cycloalkyl, aryl, arylalkyl, alkylaryl, with two radicals R⁶ also being able to be joined to one another, for example, two radicals R⁶ positioned on different carbon atoms can together be a C₂-C₅-alkylene group which may be unsubstituted or monosubstituted or disubstituted by C₁-C₂₀-alkyl, by hydroxyl, by carboxymethyl or by C₁-C₁₀-alkoxy, in particular methoxy and with a CH₂ group being able to be replaced by an oxygen atom or an N—CH₃ unit.

Further examples of N-oxyl compounds are compounds of the general formulae IV a to IV c:

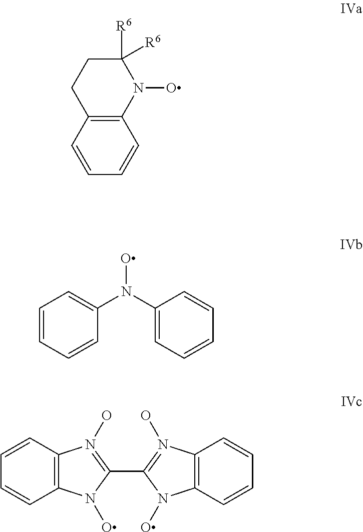

Here, the radicals R⁶ are as defined above and the aromatic rings may also bear from one to three further radicals selected from among C₁-C₁₀-alkyl, CN, NO₂ and C₁-C₄-alkoxy.

Particular preference is given to N-oxyl compounds of the general formula V a or V b

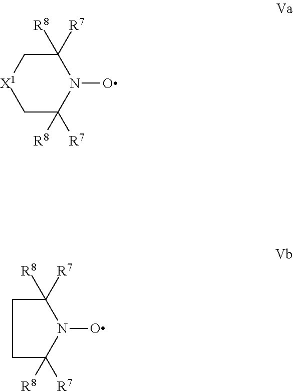

Here, R⁷ and R⁸ are different or preferably identical and are selected from among phenyl and, in particular,
C₁-C₁₀-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, isooctyl, 2-ethylhexyl, n-nonyl, n-decyl, 2-n-propylheptyl; particularly preferably C₁-C₄-alkyl such as methyl, ethyl, n-propyl, isopropyl, n-butyl, isobutyl, sec-butyl and tert-butyl, in particular methyl;
X¹ is selected from among oxygen, N—R⁹ and CR⁹R¹⁰, where R⁹ and R¹⁰ can be different or identical and are selected from among phenyl and, in particular, C₁-C₁₀-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, isooctyl, 2-ethylhexyl, n-nonyl, n-decyl, 2-n-propylheptyl; particularly preferably C₁-C₄-alkyl such as methyl, ethyl, n-propyl, isopropyl, n-butyl, isobutyl, sec-butyl and tert-butyl, in particular methyl.

Furthermore, CR⁹R¹⁹ can be a CH₂ group, a CHOH group, a C═O group, a CHOR⁹ group, where R⁹ is as defined above, a C(CH₂)₄ or C(CH₂)₅ group or a group of the general formula VI

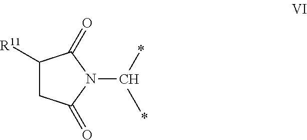

Here, R¹¹ can be hydrogen or C₁-C₂₀-alkyl, in particular n-C₅-C₁₈-alkyl such as n-pentyl, n-hexyl, n-heptyl, n-octyl, isooctyl, n-decyl, 2-n-propylheptyl, n-dodecyl, n-C₁₄H₂₉, n-C₁₆H₃₃ or n-C₁₈H₃₇.

Very particularly preferred inhibitors are TEMPO (2,2,6,6-tetramethylpiperidin-N-oxyl, formula V with R⁷═R⁸=methyl, X=carbon, R⁹═R¹⁰=hydrogen), methoxy-TEMPO (formula V with R⁷═R⁸=methyl, X=carbon, R⁹=methoxy, R¹⁰=hydrogen) or the compound VII

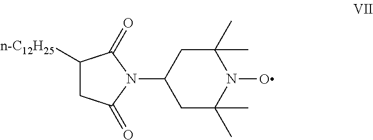

Examples of compounds which form an N-oxyl compound under the conditions of the free-radical copolymerization are O-substituted hydroxylamines of secondary amines, for the purposes of the present invention also referred to as substituted alkoxamines. Substituted alkoxamines can have, for example, the formula VIII,

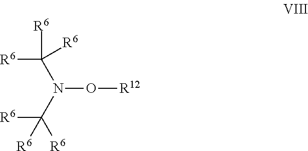

where R⁶ is as defined above and R¹² is C₁-C₂₀-alkyl, unsubstituted or preferably substituted, for example by aryl, in particular phenyl, C₁-C₂₀-alkyl, acyl, in particular COOCH₃. R⁶ is preferably selected from among C₁-C₂₀-alkyl. Examples of very particularly preferred radicals R¹² are benzyl, n-octyl and CH(COOCH₃)₂. In one embodiment, two radicals R⁶ can be joined to one another, for example two radicals R⁶ positioned on different carbon atoms can together be a C₂-C₅-alkylene group, unsubstituted or mono-substituted or disubstituted by C₁-C₂₀-alkyl, by hydroxyl, by carboxymethyl or by C₁-C₁₀-alkoxy, in particular methoxy, and a CH₂ group may be replaced by an oxygen atom or an N—CH₃ unit.

Mention may be made by way of example of the compounds of the general formulae IX a to IX d:

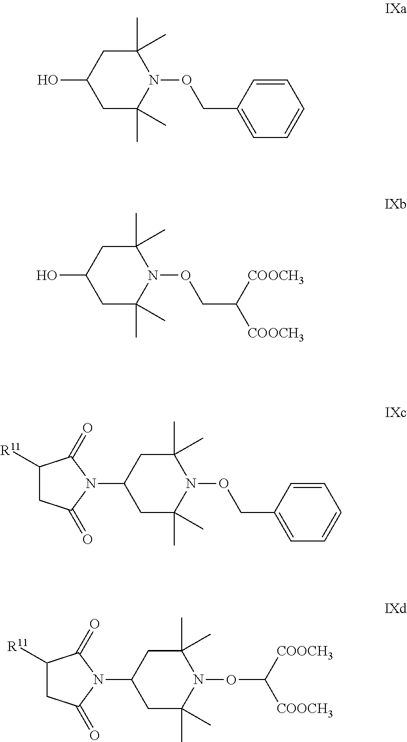

Further examples of suitable alkoxamines are dimeric alkoxamines of the general formula X,

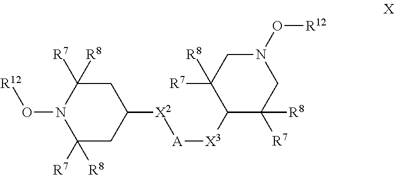

where R⁷, R⁸ and R¹² are different or in each case identical in pairs and are as defined above, A is a spacer selected from among 1,4-phenylene and C₂-C₁₀-alkylene, branched or preferably unbranched, and X² and X³ are different or preferably identical and are selected from among nitrogen, oxygen, O—C═O and C(O)O. A particularly preferred example of dimeric alkoxamines is the compound X a.

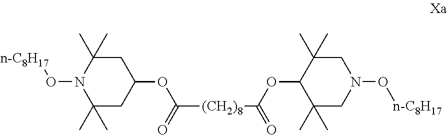

In an embodiment of the present invention, the inhibitor or inhibitors is/are introduced as a 0.01-5% strength by weight solution, preferably one to 2.5% strength by weight solution, in one or more hydrocarbons or one or more ketone(s) which is/are liquid at room temperature.

Examples of ketones which are liquid under room temperature are acetone, methyl isobutyl ketone (MK) and in particular ethyl methyl ketone. As hydrocarbons, mention may be made of aromatic hydrocarbons such as toluene, ethylbenzene, ortho-xylene, meta-xylene and para-xylene, also cycloaliphatic hydrocarbons such as cyclohexane and aliphatic C₆-C₁₆-hydrocarbons, branched or unbranched, for example n-heptane, n-octane, isooctane, n-decane, n-dodecane and in particular isododecane pentamethylheptane). Compressed ethylene, for example ethylene compressed to a pressure of at least 250 bar, can also be a suitable hydrocarbon for the metering of inhibitor. If ethylene is to be used for the metering of the inhibitor or inhibitors, preference is given to using not more than 1% by weight of the ethylene introduced into the reaction mixture for the metering of inhibitor. The appropriate amount of ethylene can for this purpose be compressed to the pressure of the reaction mixture and mixed with a very concentrated solution of inhibitor in one of the abovementioned solvents. The latter mixing step is preferably carried out immediately before the inhibitor or inhibitors is/are metered into the reaction mixture.

Inhibitor can be introduced at one or more points.

In an embodiment of the present invention, from 0.1 to 1000 ppm, preferably from 1 to 200 ppm, of inhibitor, based on the output of ethylene copolymer, is metered in. Here, ppm are in each case ppm by mass.

In an embodiment of the present invention, one or more regulators, for example one or more aliphatic aldehydes such as propionaldehyde or one or more ketones such as acetone or ethyl methyl ketone (2-butanone), are introduced in addition to inhibitor.

In an embodiment of the present invention, one or more inhibitors in one of the comonomers (b) are additionally metered in, as described in WO 01/60875 or DE 196 22 441.

The process of the invention gives copolymers of ethylene and at least one of the abovementioned comonomers (b) which overall have advantageous use properties. They usually have only very small or no detectable proportions of ethylene copolymer which comprises a greatly below-average proportion of copolymerized ethylenically unsaturated carboxylic acid, of copolymerized ester of ethylenically unsaturated carboxylic acid, of copolymerized ethylenically unsaturated phosphonic acid or copolymerized ester of ethylenically unsaturated phosphonic acid. The present invention therefore further provides copolymers of ethylene with at least one comonomer (b) selected from among ethylenically unsaturated carboxylic acids, esters of ethylenically unsaturated carboxylic acids, ethylenically unsaturated phosphonic acids and esters of ethylenically unsaturated phosphonic acids. Ethylene copolymers according to the invention have a particularly narrow comonomer distribution, i.e. a small proportion of high molecular weight of molecules having a low proportion of copolymerized comonomer (b). If, for example, ethylene copolymers according to the invention are to be emulsified, it is in some cases possible to make do with only small proportions of emulsifier, and in other cases it is possible to dispense with an emulsifier. Emulsions which have excellent transparency and can be produced without leaving a residue are obtained. The emulsions produced according to the invention can, for example, be used as or for producing floor care products or as coating compositions, for example for corrosion protection, also as auxiliaries in wastewater treatment or in paper production.

Further fields of use are lubricants in the processing of PVC (polyvinyl chloride), in particular unplasticized PVC, as auxiliaries in food packaging films or as temporary antifingerprint coatings.

The invention is illustrated by examples.

### I. Preparation According to the Invention of Ethylene Copolymers

### I.1 Preparation According to the Invention of Ethylene Copolymers A.1 to A.5 and Comparative Copolymer C-A.6

Ethylene copolymers A.1 to A.5 and comparative copolymer C-A.6 are each copolymers which comprise 81% by weight of ethylene and about 19% by weight of methacrylic acid (in each case copolymerized proportions), have a melt flow index MFI (160° C., 325 g) of 10 dg/min and are prepared in a cascade comprising a high-pressure autoclave with a downstream tube reactor.

The copolymerization was carried out continuously in a cascade comprising a stirred high-pressure autoclave having a volume of 351 and a tube reactor having a length of about 200 m and an internal diameter of 15 mm; the throughput of ethylene was about 1.4 t/h and that of methacrylic acid was about 50 kg/h. In the stirred high-pressure autoclave, the copolymerization was initiated by means of a peroxide solution (tert-amyl peroxypivalate and Cert-butyl peroxy-2-ethylhexanoate, proportions by weight 3:4, total of 10% by weight) in isododecane. No initiator was introduced in the tube reactor.

The copolymerization reaction was allowed to abate in the tube reactor before the reaction mixture was depressurized to about 400 bar at a pressure regulating valve, resulting in the temperature increasing by about 25° C. The pressure in the cascade was 2200 bar, and the maximum temperature was 245° C. As molecular weight regulator, 0.8 l/h of propionaldehyde (PA) were metered in on the suction side of the after-compressor. The tube reactor was cooled by means of pressured water having a temperature of 200° C. In examples A.1 to A.5, polymerization inhibitor was metered in as shown in table 1 at the transition between the autoclave and the tube reactor. In comparative example C-A.6, no inhibitor was introduced.

The following inhibitors, in each case as a solution in isododecane, were used:

I-1: Solution (2% by weight) of TEMPO in isododecane
I-2: Solution (4% by weight) of 4-methoxy-TEMPO in isododecane
I-3: Solution (5% by weight) of n-dodecylsuccinimido-TEMPO (VII, see above) in isododecane

### I.2 Preparation According to the Invention of Ethylene Copolymer B.1 and Comparative Copolymer C-B.2

Ethylene copolymer B.1 and comparative copolymer C-B.2 are each copolymers which comprise 74% by weight of ethylene and about 26% by weight of methacrylic acid (in each case copolymerized proportions), have a melt flow index MFI (160° C., 325 g) of 10 dg/min and are prepared in a cascade comprising a high-pressure autoclave with a downstream tube reactor.

A cascade as described in example I.1 was used. The procedure was as in example I.1, but only 0.3 l/h of propionaldehyde (PA) was metered in on the suction side of the after-compressor and about 70 kg/h of methacrylic acid was fed in.

TABLE 1
Experimental data for the ethylene copolymers prepared according to the
invention A.1 to A.5 and B.1 and also for the comparative copolymers

| | | | Inhibitor, | | | |
|---|---|---|---|---|---|---|
| | | | proportion | Peroxide | | |
| Ethylene | | Inhibitor- | by mass | consumption | MFI | Acid number |
| copolymer | Output [t/h] | type | [ppm] | [g/t] | [dg/min] | [mgKOH/g] |
| A.1 | 0.235 | I-1 | 30 | 1900 | 10.8 | 121 |
| A.2 | 0.23 | I-2 | 32 | 1980 | 10.9 | 123 |
| A.3 | 0.235 | I-3 | 29 | 1990 | 10.0 | 118 |
| A.4 | 0.235 | I-3 | 51 | 1910 | 10.1 | 125 |
| A.5 | 0.245 | I-3 | 98 | 2070 | 11.0 | 119 |
| C-A.6 | 0.25 | — | 0 | 1945 | 11.2 | 119 |
| B.1 | 0.23 | I-1 | 48 | 2552 | 10.4 | 177 |
| C-B.2 | 0.245 | — | 0 | 2500 | 9.9 | 171 |

The inhibitors were metered in by means of a high-pressure pump. The metering rate was in the range from 0.2 l/h to 1.3 l/h.

The peroxide consumption is reported in g of peroxide/metric t of ethylene copolymer or g of peroxide/metric t of comparative copolymer.

### II. Production of Emulsions

The amount indicated in table 2 of ethylene copolymer from example I was placed in a 1 liter autoclave provided with an anchor stirrer. The amine indicated in table 2 was added, the mixture was made up to 100 g and heated to 98° C. while stirring. After stirring for 3 hours at 98° C., the mixture was cooled to room temperature over a period of 15 minutes. The dispersions produced according to the invention and the comparative dispersions as shown in table 2 were obtained.

TABLE 2
Composition of the emulsions produced according
to the invention and comparative emulsions

| | | Amount of | | Amount of | |
|---|---|---|---|---|---|
| Emulsion | ECP | ECP [g] | Amine | amine [g] | LT [%] |
| E.1-A.1 | A.1 | 25.0 | Amine 1 | 3.4 | 68 |
| E.1-A.2 | A.2 | 25.0 | Amine 1 | 3.4 | 69 |
| E.1-A.3 | A.3 | 25.0 | Amine 1 | 3.4 | 72 |
| E.1-A.4 | A.4 | 25.0 | Amine 1 | 3.4 | 70 |
| E.1-A.5 | A.5 | 25.0 | Amine 1 | 3.4 | 71 |
| C-E.1-A.6 | C-A.6 | 25.0 | Amine 1 | 3.4 | Not emulsifi- |
| | | | | | able (residue |
| | | | | | present) |
| E.1-B.1 | B.1 | 25.0 | Amine 1 | 3.4 | 85 |
| C-E.1-B.2 | C-B.2 | 25.0 | Amine 1 | 3.4 | 80 |
| E.2-A.1 | A.1 | 21.3 | Amine 2 | 3.6 | 80 |
| E.2-A.2 | A.2 | 21.3 | Amine 2 | 3.6 | 86 |
| E.2-A.3 | A.3 | 21.3 | Amine 2 | 3.6 | 85 |
| E.2-A.4 | A.4 | 21.3 | Amine 2 | 3.6 | 91 |
| E.2-A.5 | A.5 | 21.3 | Amine 2 | 3.6 | 89 |
| C-E.2-A.6 | C-A.6 | 21.3 | Amine 2 | 3.6 | 75 |
| E.2-B.1 | B.1 | 21.3 | Amine 2 | 3.6 | 95 |
| C-E.2-B.2 | C-B.2 | 21.3 | Amine 2 | 3.6 | 89 |

ECP: Ethylene copolymer
Amine 1: NH₃ as g of a 25% strength aqueous solution, amine 2: (CH₃)₂NCH₂Ch₂OH
The LT (light transmittance) was in each case measured on a mixture of 1 g of the respective emulsion and 400 g of water at a wavelength of 533 nm in a 5 cm fused silica cell. The maximum achievable value is 100%.

When the inhibitors I-1 to I-3 were used, an additional check was made to determine the extent to which discoloration takes place for the example of ethylene-methacrylic acid copolymers comprising 19% by weight of MA. The inhibitors I-1 to I-3 were in each case dissolved in isododecane (see above). 2 mm thick compacts were produced from copolymer A.1 admixed with inhibitor and were examined optically. No discoloration was found in the visible wavelength range up to concentrations of 100 ppm of inhibitor.

1-10. (canceled)

11. A process for the continuous preparation of an ethylene copolymer comprising reacting ethylene (a) and at least one comonomer (b) selected from the group consisting of ethylenically unsaturated carboxylic acids, esters of ethylenically unsaturated carboxylic acids, ethylenically unsaturated phosphonic acids, and esters of ethylenically unsaturated phosphonic acids, via free-radical copolymerization, wherein at least one inhibitor are metered separately from (a) and (b) into the reaction mixture.

12. The process of claim 11, wherein said at least one inhibitor is metered into the reaction mixture in the form of a 0.01 to 5% by weight solution, the solvent of which is at least one hydrocarbon or at least one ketone which is liquid at room temperature.

13. The process of claim 11, wherein said at least one inhibitor comprises an N-oxyl compound or a compound which forms an N-oxyl compound under the conditions of the free-radical copolymerization.

14. The process of claim 11, wherein said process is carried out in a cascade selected from the groups consisting of cascades comprising at least two high-pressure autoclaves, cascades comprising at least two tube reactors, and cascades comprising a high-pressure autoclave and a tube reactor.

15. The process of claim 11, comprising reacting from 60 to 98% by weight of ethylene;
(a) from 2 to 40% by weight of at least one comonomer selected from the group consisting of ethylenically unsaturated carboxylic acids, esters of ethylenically unsaturated carboxylic acids, ethylenically unsaturated phosphonic acids, and esters of ethylenically unsaturated phosphonic acids; and
(b) optionally at least one further comonomer; via free-radical copolymerization, wherein the percentages by weight in each case are based on the weight of the resulting ethylene copolymer.

16. The process of claim 11, wherein the free-radical copolymerization reaction is carried out at a temperature in the range of from 120° C. to 350° C.

17. The process of claim 11, wherein the free-radical copolymerization reaction is carried out at a pressure in the range of from 500 to 5000 bar.

18. The process of claim 11, wherein the resulting ethylene copolymer has a molecular weight Mₙ of up to 20,000 g/mol.

19. The process of claim 11, wherein the free-radical copolymerization reaction is carried out in a cascade comprising a high-pressure autoclave followed by a tube reactor and said at least one inhibitor is metered into the reaction mixture at a point between said high-pressure autoclave and said tube reactor or is metered directly into said tube reactor.

20. An ethylene copolymer prepared by the process of claim 11.
